(19) United States
(12) Patent Application Publication
(10) Pub. No.: US 2006/0220439 A1
(43) Pub. Date: Oct. 5, 2006

(54) Wheel frame made of compound material

(76) Inventor: Mu-Rong Li, Taichung (TW)

Correspondence Address: Mu-Rong Li, 235 Chung-Ho, Box 8-24, Taipei, TW

(21) Appl. No.: 11/093,250

(22) Filed: Mar. 29, 2005

(51) Int. Cl. B60B 21/02

(52) U.S. Cl. 301/31

(57) ABSTRACT

A wheel frame made of compound material comprises a wheel frame body formed by a plurality of sub-frames; one side of each sub-frame being protruded with a male joint and another side thereof being formed with an female hole corresponding to the male joint; a lower end of each sub-frame being installed with a frame portion made of compound material and an upper end thereof is formed with an aluminum alloy supporting portion which can suffer from a greater deformation; the aluminum alloy supporting portion serving for receiving a tire. In assembly, the male joint is engaged to the female hole of another sub-frame tightly; then the process is continuous so as to form a round wheel frame. Furthermore, in the present invention, the aluminum alloy supporting portion can be replaced by a compound material supporting portion and the compound material supporting portion is integrally formed with a frame portion.

### FIELD OF THE INVENTION

The present invention relates to wheel frames, and in particular to a wheel frame made of compound material, wherein the sub-frame has a preferred flatness and roundness so that the bicycle has a strong structure. Thus, the rider is safe in driving.

### BACKGROUND OF THE INVENTION

For current leisure sport trend, riding bicycles have become an important sport for many people and thus the safety in driving more and more captures people's attention. Currently carbon fiber is a main material for manufacturing wheel frames of the bicycle.

In one prior art, the wheel frame is made by two semi-round structures. The connections of the semi-round structures have ribs as connecting means.

However above mentioned structure has the following disadvantages. In the manufacturing process, the carbon fiber must be cooled and heated repeatedly, but this will make the wheel frame become unflat because the length of the carbon fiber is prolonged so that the frame will deform. Furthermore, the carbon fiber is unbendable, and thus the roundness of the wheel frame becomes worse. Furthermore, the deformation of the carbon fiber is difficult so that the yield ratio of the wheel frame is low. As a result the cost is high and the manufacturing process is low. Moreover the frame made by carbon fiber is large, and thus its strength is low. As the wheel frame is collided so that the wheel deforms, then the whole wheel frame must be deserted and a new one is required. Furthermore, to form a semi-round wheel frame must be made by a great machine which is cost-ineffective. Further, the connections of the semi-round wheel frames are performed by ribs and thus the structure is to weak to suffer from a great collision.

### SUMMARY OF THE INVENTION

Accordingly, the primary object of the present invention is to provide a wheel frame made of compound material, wherein the wheel frame has a preferred flatness and roundness so that the bicycle has a strong structure. Thus, the rider is safe in driving.

To achieve above objects, the present invention provides a wheel frame made of compound material which comprises a wheel frame body formed by a plurality of sub-frames; one side of each sub-frame being protruded with a male joint and another side thereof being formed with an female hole corresponding to the male joint; a lower end of each sub-frame being installed with a frame portion made of compound material and an upper end thereof is formed with an aluminum alloy supporting portion which can suffer from a greater deformation; the aluminum alloy supporting portion serving for receiving a tire. In assembly, the male joint is engaged to the female hole of another sub-frame tightly; then the process is continuous so as to form a round wheel frame body; then the wheel frame body is fixed upon a fixture so as to tightly engage the engagement of the male joints to the female holes.

Furthermore, in the present invention, the aluminum alloy supporting portion can be replaced by a compound material supporting portion and the compound material supporting portion is integrally formed with a frame portion.

The various objects and advantages of the present invention will be more readily understood from the following detailed description when read in conjunction with the appended drawing.

### BRIEF DESCRIPTION OF THE DRAWINGS

FIG. 1 is an exploded schematic view of the wheel frame of the present invention.

FIG. 2 is an assembled schematic view showing the details of the wheel frame of the present invention.

FIG. 3 is a schematic view showing the tightening operation of the wheel frame of the present invention.

FIG. 4 is a plane schematic view of the wheel frame of the present invention.

FIG. 5 is a schematic view showing the assembly view of the wheel frame of the present invention.

FIG. 6 is an exploded schematic view about the second embodiment of wheel frame of the present invention.

FIG. 7 is an assembled view about the wheel frame in the second embodiment of the present invention.

### DETAILED DESCRIPTION OF THE INVENTION

In order that those skilled in the art can further understand the present invention, a description will be described in the following in detail. However, these descriptions and the appended drawings are only used to cause those skilled in the art to understand the objects, features, and characteristics of the present invention, but not to be used to confine the scope and spirit of the present invention defined in the appended claims.

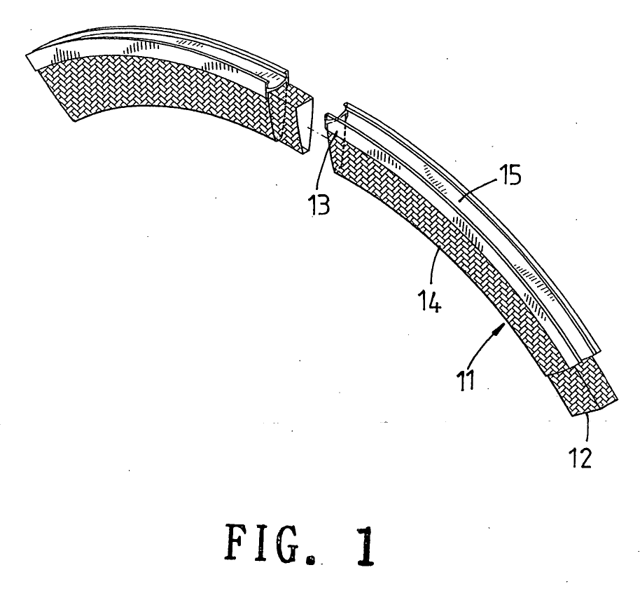

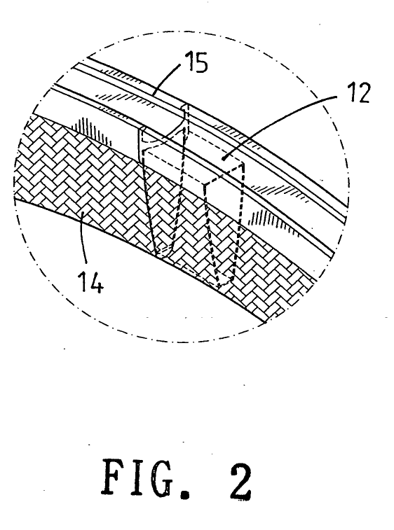

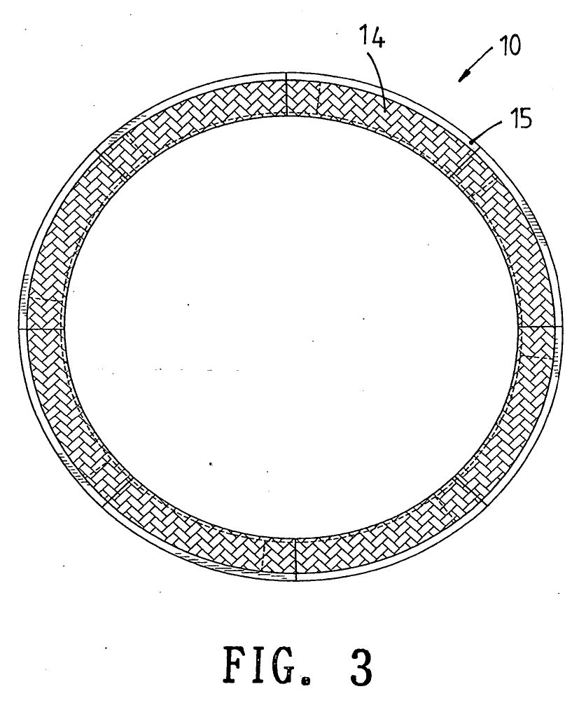

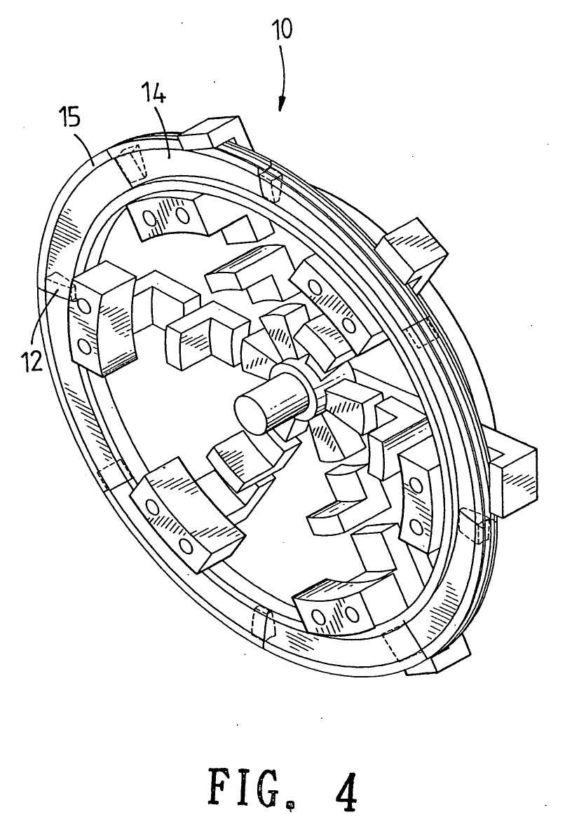

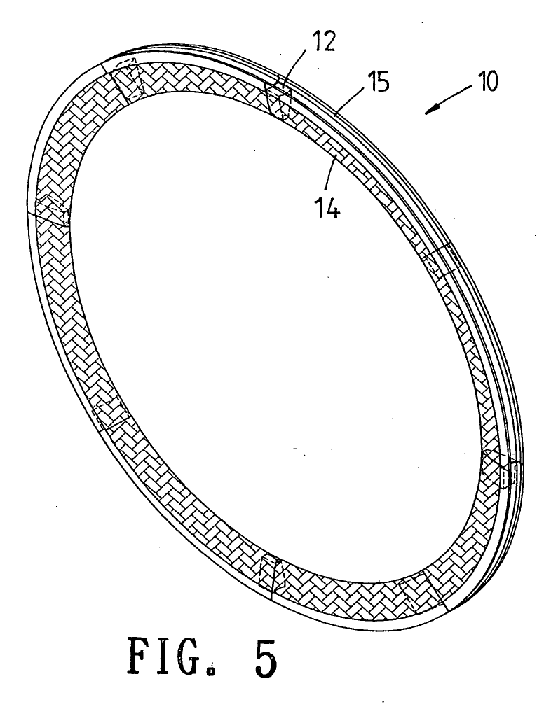

With reference to FIGS. 1 to 5, the present invention has the following elements.

A wheel frame body 10 is formed by a plurality of sub-frames 11. Arcs of the sub-frames 11 are identical. One side of each sub-frame 11 is protruded with a male joint 12 and another side thereof is formed with a female hole 13 corresponding to the male joint 12. A lower end of each sub-frame 11 is installed with a tapered frame portion 14 made of compound material and an upper end thereof is formed with an aluminum alloy supporting portion 15 which can suffer from a greater deformation. The aluminum alloy supporting portion 151 serves for receiving a tire.

In assembly, the adhesion agent is coated on the male joint 12 of the sub-frame 11. Then the male joint 12 is engaged to the female hole 13 of another sub-frame 11 tightly. Then the process is continuous so as to form a round wheel frame body 10. Then the wheel frame body 10 is fixed upon a fixture so as to tightly engage the male joints 12 to the female holes 13 so as to have a preferred flatness and roundness so that the bicycle has a strong structure. Thus, the rider is safe in driving.

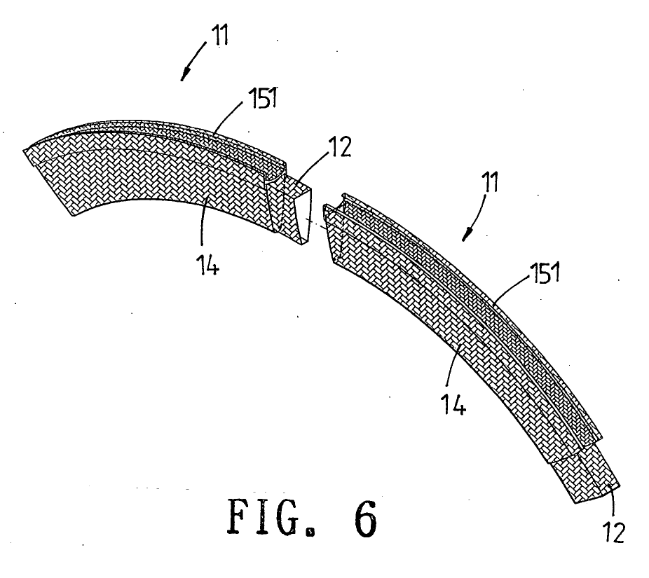

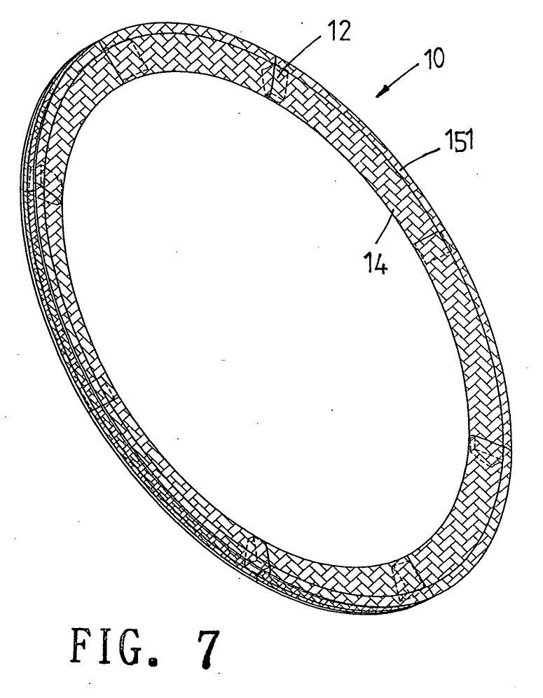

Referring to FIGS. 6 and 7, the second embodiment of the present invention is illustrated.

A wheel frame body 10 is formed by a plurality of sub-frames 11. Arcs of the sub-frames 11 are identical. One side of each sub-frame 11 is protruded with a male joint 12 and another side thereof is formed with a female hole 13 corresponding to the male joint 12. A lower end of each sub-frame 11 is installed with a tapered frame portion 14 made of compound material and an upper end thereof is formed with a compound material supporting portion 151 for receiving a tire. The compound material supporting portion 151 is integrally formed with the frame portion 14 of the wheel frame body 10 so as to enhance the strength of the wheel frame and to reduce the weight of the wheel frame.

In assembly, the adhesion agent is coated on the male joint 12 of the sub-frame 11. Then the male joint 12 is engaged to the female hole 13 of another sub-frame 11 tightly. Then the process is continuous to form a round wheel frame body 10. Then the wheel frame body 10 is fixed upon a fixture to tightly engage the male joints 12 to the female holes 13 so as to have a preferred flatness and roundness so that the bicycle has a strong structure. Thus, the rider is safe in driving.

The compound material is carbon fiber.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A wheel frame made of compound material comprising:
a wheel frame body formed by a plurality of sub-frames; one side of each sub-frame being protruded with a male joint and another side thereof being formed with an female hole corresponding to the male joint; a lower end of each sub-frame being installed with a frame portion made of compound material and an upper end thereof being formed with an aluminum alloy supporting portion which can suffer from a greater deformation; the aluminum alloy supporting portion serving for receiving a tire;
wherein in assembly, the male joint of one of the sub-frame is engaged to the female hole of another sub-frame tightly; then the process is continuous so as to form a round wheel frame body; then the wheel frame body is fixed upon a fixture to tightly engage the male joints to the female holes.

2. The wheel frame made of compound material as claimed in claim 1, wherein the compound material is carbon fiber.

3. The wheel frame made of compound material as claimed in claim 1, wherein arcs of the sub-frames are identical.

4. The wheel frame made of compound material as claimed in claim 1, wherein adhesion agent is coated on the male joint of the sub-frame.

5. A wheel frame made of compound material comprising:
a wheel frame body formed by a plurality of sub-frames; one side of each sub-frame being protruded with a male joint and another side thereof being formed with an female hole corresponding to the male joint; a lower end of each sub-frame being installed with a frame portion made of compound material and an upper end thereof being formed with a compound material supporting portion for receiving a tire; the compound material supporting portion being integrally formed with the frame portion of the wheel frame body to enhance the strength of the wheel frame and to reduce the weight of the wheel frame;
wherein in assembly, the male joint is engaged to the female hole of another sub-frame tightly; then the process is continuous so as to form a round wheel frame body; then the wheel frame body is fixed upon a fixture so as to tightly engage the engagement of the male joints to the female holes.

2. The wheel frame made of compound material as claimed in claim 1, wherein the compound material is carbon fiber.

3. The wheel frame made of compound material as claimed in claim 1, wherein arcs of the sub-frames are identical.

4. The wheel frame made of compound material as claimed in claim 1, wherein adhesion agent is coated on the male joint of the sub-frame.
